(19) United States
(12) Patent Application Publication
(10) Pub. No.: US 2009/0013544 A1
(43) Pub. Date: Jan. 15, 2009

(54) METHOD FOR DETECTING AN ORIENTATION OF A DEVICE AND DEVICE HAVING AN ORIENTATION DETECTOR

(75) Inventors: Bernardus H.W. Hendriks, Eindhoven (NL); Stein Kuiper, Vught (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,923

(22) PCT Filed: Jan. 13, 2005
(86) PCT No.: PCT/IB05/50151

§ 371 Date: Jun. 29, 2006

(30) Foreign Application Priority Data
Jan. 15, 2004 (EP) 04100120.7
Nov. 11, 2004 (GB) 0424890.2

(51) Int. Cl. G01C 9/06

(52) U.S. Cl. 33/366.16

(57) ABSTRACT

The present invention discloses a method for detecting an orientation of a device (1) with respect to a direction of an acceleration force and a device (1) comprising an optical device (10) comprising a first liquid (A) and a second liquid (B), said liquids (A; B) being immiscible, having different refractive indices and different densities and being in contact with each other via an interface (14), a sensor (20) comprising a grid of pixels (22), the sensor (20) being arranged to sense an image captured by the optical device (10) on a subset (24, 24′) of the grid of pixels (22); and calculating means (30) for calculating an orientation of the device (1) with respect to a direction of an acceleration force from the position of the subset (24, 24) on the grid (22). Consequently, the orientation of the device (1) with respect to the direction of an acceleration force such as gravity can be obtained without mechanically moving parts.

The present invention relates to a method for detecting an orientation of a device.

The present invention further relates to a device having an orientation detector.

The detection of the orientation of a device with respect to an acceleration force such as gravity is of interest in numerous application domains. Examples of such application domains include aviation, computing, security and virtual reality applications such as gaming. In European patent application EP1040357, an acceleration sensor is disclosed that can act as a detector of an orientation with respect to the field of gravity. The acceleration sensor comprises a non-conducting, non-magnetic housing with a chamber, in which an induction-influencing member coupled to a coil is placed. Upon a change in orientation of the device in which the sensor is placed, the self-inductance of the member changes, which can be detected via the coil. This sensor has the disadvantage that it relies on mechanically moving parts for the orientation detection, which suffer from mechanical wear during the life of the sensor.

The present invention seeks to provide an orientation detection method according to the opening paragraph that avoids or at least reduces mechanical wear.

The present invention further seeks to provide a device having an orientation detector that suffers less from mechanical wear.

According to a first aspect of the present invention, there is provided a method of detecting an orientation of a device with respect to a direction of an acceleration force, comprising providing a device having an optical device comprising a first liquid and a second liquid, said liquids being immiscible, having different refractive indices and different densities and being in contact with each other via an interface, and a sensor comprising a grid of pixels; sensing an image captured by the optical device on a subset of the grid of pixels; and calculating the orientation of the device from the position of the subset on the grid.

The method is based on the realization that an optical device such as a variable focus lens disclosed in PCT patent application WO2003/069380 can be modified to serve as an orientation detector for detecting an orientation of the device with respect to a direction of an acceleration force such as gravity. To this end, the densities of the liquids in the optical device are chosen to be different, which makes their orientation inside the device dependent on the direction of the acceleration force, e.g. gravity. Because of the different refractive indices of the liquids, a change in the orientation of the device will cause a change in the trajectory of the light through the optical device.

Typically, the grid of pixels of the image sensor behind the optical device are only partially exposed to an image captured by the optical device, that is, the grid of pixels is larger than the area of exposure. By detecting which pixels are not exposed to the image captured by the optical device, the orientation of the image on the grid can be determined. Since this orientation is a function of gravity or another acceleration force, the orientation of the device with respect to the direction of such a force can be calculated.

According to a further aspect of the invention, there is provided a device comprising an optical device comprising a first liquid and a second liquid, said liquids being immiscible, having different refractive indices and different densities and being in contact with each other via an interface; comprise a sensor comprising a grid of pixels, the sensor being arranged to sense an image captured by the optical device on a subset of the grid of pixels; and calculating means for calculating an orientation of the device with respect to a direction of an acceleration force from the position of the subset on the grid.

This device, which may be an electronic device such as a mobile phone, a control device used in aviation, an electronic spirit level and so on, implements the method of the present invention, and has the advantage that no mechanically moving parts are required to determine the orientation of the device.

In an embodiment, the first liquid is an electrically susceptible liquid. This allows for manipulation of the position of the liquid by means of an applied electric field. To facilitate this manipulation, the optical device further comprises an electrode structure in conductive contact with the first liquid, and the device further comprises driver circuitry coupled to the electrode structure. This has the advantage that the optical device can also be used as variable focus lens, for instance.

In another embodiment, the second liquid comprises a mixture of oils. This is advantageous, because oils generally mix well, and a wide range of oils with various densities are readily available, which allows for a careful tuning of the overall density of the second liquid. This is important, because in case of the optical device being a lens, the difference in density will contribute to optical aberrations including unwanted higher order aberrations such as coma and astigmatism. By carefully selecting the densities of the first and second liquid, the change in the orientation of the interface can be reduced to mainly a tilt, with the interface deformation from a sphere remaining small, thus reducing the aforementioned higher order aberrations.

Advantageously, the calculating means comprise a memory element for storing calibration data, the calculating means being arranged to calculate the orientation using the calibration data. At production, the orientation detector is calibrated by performing a number of measurements under predefined orientations, and storing the calibration results in the memory element, which may be as simple as a look up table (LUT). During operation, the processing means compare the position of the subset of pixels on the grid with the calibration data and calculate the orientation from this comparison.

In another embodiment, the device further comprises a light source in front of the optical device. This has the advantage that the device can also be used by night. Preferably, the light source is removable, to allow for another use of the optical device, e.g. as variable focus lens.

The invention is described in more detail and by way of non-limiting examples with reference to the accompanying drawings, wherein:

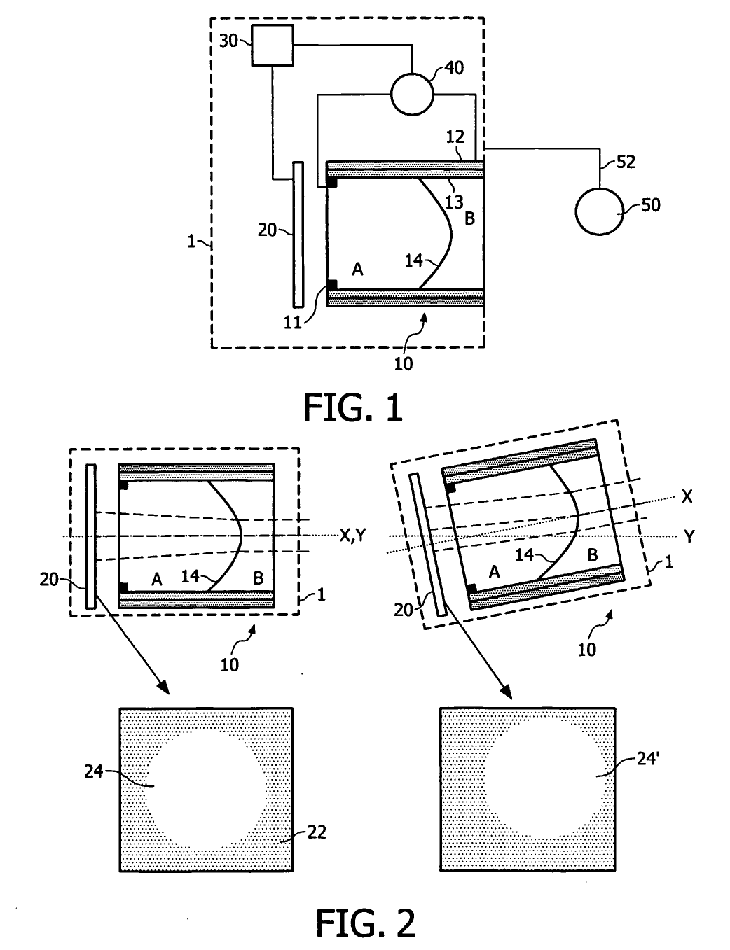

FIG. 1 shows a device according to the present invention; and

FIG. 2 schematically depicts the influence of an acceleration force on the orientation of an image on the pixel grid of an image sensor.

It should be understood that the Figures are merely schematic and are not drawn to scale. It should also be understood that the same reference numerals are used throughout the Figures to indicate the same or similar parts.

FIG. 1 depicts a device 1 according to the present invention. The device 1, which may be an electronic device such as a mobile phone or an orientation determining instrument for use in aviation applications or domestic applications, has an optical device 10 placed in front of an image sensor 20. The image sensor 20 is arranged to provide an output signal to a processor 30. The optical device 10 comprises a first liquid A and a second liquid B enclosed in a chamber having a coating 13 on the inner wall. The first liquid A and the second liquid B are immiscible and are in contact with each other via an interface 14. The coating 13 is chosen to manipulate the curvature of the interface 14. For instance, liquid A may be a hydrophobic liquid such as an oil and liquid B may be a hydrophilic liquid, such as an aqueous salt solution. A hydrophobic coating 13 on the inner wall of the chamber of the optical device 10, such as AF1600™ from the DuPont company, causes the inner wall to be predominantly covered by the hydrophobic liquid, which forces the interface 14 in a convex orientation, as shown in FIG. 1. A more extensive explanation of the function of the coating 13 can be found in PCT patent application WO2003/069380.

According to the present invention, the first liquid A and the second liquid B have a different refractive index and a different density to ensure that the trajectory of the light through the optical device changes when the orientation of the optical device 10 is altered. This will be explained in more detail later. The optical device 10 may be a passive device dedicated to orientation detection. Alternatively, the optical device 10 may be a configurable device having a dual function, with the other function for instance being a variable focus lens. In this embodiment, one of the liquids A, B of the optical device is an electrically susceptible liquid, with the optical device 10 further comprising a first electrode 11, which may be an annular electrode and a second electrode 12, which may be a wall electrode. In this embodiment, the device 1 further comprises a driver circuit 40, with the processor 30 being arranged to control the driver circuit 40, which is arranged to provide a variable voltage across the first electrode 11 and the second electrode 12 to manipulate the shape of the interface 14 and, consequently, the optical power of the optical device 10. This principle is for instance well known from the aforementioned PCT application and will not be further explained. In accordance with well-known techniques, the optical device 10 may be extended with an optical stop or a diaphragm (not shown) and/or with a lens hood or a sunshade (not shown) to control the width of the light beam passing through the optical device 10.

Optionally, the device 1 further comprises a light source 50 mounted on a holder 52 to facilitate an orientation measurement in the dark. The light source 50 may be removable from the holder 52, and the holder 52 may be removable from the device 1.

The operation of the device 1, i.e. the way in which the method of the present invention is implemented in the device 1 is explained in FIG. 2. In FIG. 2, the processor 30 and the optional driver circuit 40 are omitted for reasons of clarity only. The left hand side of FIG. 2 shows the optical device 10 in a first orientation. The light beam that passes through the optical device 10 is indicated by the bundle of dashed lines. The interface 14 operates as a lens, causing the light beam to diverge for this particular orientation of the interface 14. Obviously, the properties of the optical device 10 can be tuned to create a converging light beam; this can be advantageous if the detector behind the optical device 10 is smaller than the area of the optical path through the optical device 10. In the first orientation, the centre of the light beam coincides with the optical axis X through the optical device 10. In the left hand figure, the optical axis X is oriented in parallel with the principal direction of the acceleration force, e.g. gravity, as indicated by line Y.

The trajectory of the light passing through the optical device 10 is measured, preferably on the grid of pixels 22 of the sensor 20, although other means of detection can be thought of, e.g. an array of discrete sensors. The light beam covers an area 24 of the grid of pixels 22. The area 24 covers a subset of pixels of the grid of pixels 22. The pixels of the sensor 20 outside the area 24 remain unexposed in the first orientation.

In a second orientation of the device 1, as shown on the right hand side of FIG. 2, the device 1 is tilted with respect to the gravitational field indicated by line Y. Because of the different densities of the first liquid A and the second liquid B, the interface 14 tilts with respects to the optical axis X under the influence of gravity. Consequently, the trajectory of the light through the optical device 10 changes, i.e. the centre of a light beam passing through the optical device 10 no longer coincides with the optical axis X upon exiting the optical device 10, and the exposed area 24′ of grid of pixels 22 of the sensor 20 is shifted in comparison to the exposed area 24. In other words, the subset of pixels that are exposed in the first orientation of the device 1 differs from the subset of pixels in the second orientation of the device 1, with the difference being a function of the orientation. Thus, the trajectory of the light passing through the optical device 10 contains information about the orientation of the optical device 10 and the device 1 in which the optical device 10.

In accordance with the method of the present invention, the orientation of the device 1 is calculated from the measured trajectory. In an embodiment, the processor 30 comprises a memory element (not shown) such as a look up table, in which calibration data is stored. The calibration data can be generated during or after assembly of the device 1, by placing the device 1 in a number of predefined orientations and storing information identifying the exposed subset of pixels in the memory element for each orientation. During operation, the processor can extrapolate the orientation of the device 1 from the calibration data in the memory element. Alternatively, the calibration data is embedded in hardware.

At his point, it is pointed out that higher order aberrations such as coma arise from a deviation of a hemispherical shape of the interface 14. The occurrence of such aberrations are also orientation dependent. Although higher order effects preferably are kept as small as possible, the quantification of these effects can be included in the orientation determination of the device 1 by evaluating the shape of the exposed area 24 of pixels 22 on the sensor 20.

It is emphasized that in the context of the present invention, the phrase ‘an electrically susceptible liquid’ is intended to include conductive liquids, polar liquids and polarizable liquids, as well as liquids responsive to a magnetic field.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of detecting an orientation of a device (1) with respect to a direction of an acceleration force, comprising:
providing a device (1) having an optical device (10) comprising a first liquid (A) and a second liquid (B), said liquids (A; B) being immiscible, having different refractive indices and different densities and being in contact with each other via an interface (14); and a sensor (20) comprising a grid of pixels (22);
sensing an image captured by the optical device (10) on a subset (24, 24′) of the grid of pixels (22); and
calculating the orientation of the device (1) from the position of the subset (24, 24′) on the grid (22).

2. A method as claimed in claim 1, wherein the acceleration force is gravity.

3. A device (1) comprising:
an optical device (10) comprising a first liquid (A) and a second liquid (B), said liquids being immiscible, having different refractive indices and different densities and being in contact with each other via an interface (14);
a sensor (20) comprising a grid of pixels (22), the sensor (20) being arranged to sense an image captured by the optical device (10) on a subset (24, 24′) of the grid of pixels (22); and
calculating means (30) for calculating an orientation of the device (1) with respect to a direction of an acceleration force from the position of the subset (24, 24′) on the grid (22).

4. A device (1) as claimed in claim 3, wherein the first liquid (A) is an electrically susceptible liquid.

5. A device (1) as claimed in claim 4, wherein the optical device (10) further comprises an electrode structure (11, 12) in conductive contact with the first liquid (A), and wherein the device (1) further comprises driver circuitry (40) coupled to the electrode structure (11, 12).

6. A device (1) as claimed in claim 3, wherein the second liquid (B) comprises a mixture of oils.

7. A device (1) as claimed in claim 3, wherein the calculating means comprise a memory element for storing calibration data, the calculating means being arranged to calculate the orientation using the calibration data.

8. A device (1) as claimed in claim 3, further comprising a light source (50) in front of the optical device (10).

9. A device (1) as claimed in claim 8, wherein the light source (50) is removable.

10. A device as claimed in claim 3, wherein the acceleration force is gravity.
